(19) United States
(12) Patent Application Publication
(10) Pub. No.: US 2025/0379676 A1
(43) Pub. Date: Dec. 11, 2025

(54) TIME SYNCHRONIZATION SYSTEM, TIME SYNCHRONIZATION DEVICE, AND RECORDING MEDIUM

(71) Applicant: Mitsubishi Electric Corporation, Tokyo (JP)

(72) Inventor: Fumihito NAKANO, Tokyo (JP)

(73) Assignee: Mitsubishi Electric Corporation, Tokyo (JP)

(21) Appl. No.: 18/878,673

(22) PCT Filed: Sep. 28, 2022
(86) PCT No.: PCT/JP2022/036323

§ 371 Date: Dec. 24, 2024

(51) Int. Cl. H04J 3/06

(52) U.S. Cl. CPC H04J 3/0641

(57) ABSTRACT

A time-synchronization system includes a first time-synchronization device, a second time-synchronization device, a third time-synchronization device, and a fourth time-synchronization device each to perform time synchronization as a master station or a device station. In the first time-synchronization device, the second time-synchronization device, the third time-synchronization device, or the fourth time-synchronization device, a master station determiner determines whether the time-synchronization device performs control as the master station based on a parameter predetermined by a user, and a time synchronizer performs the time synchronization as the master station when the time-synchronization device is determined to perform control as the master station and performs the time synchronization as the device station when the time-synchronization device is determined not to perform control as the master station.

### TECHNICAL FIELD

The present disclosure relates to a time-synchronization system, a time-synchronization device, a time-synchronization method, and a program.

### BACKGROUND ART

A time-synchronization system for synchronizing time between devices in a network uses a standard such as Institute of Electrical and Electronics Engineers (IEEE) 802.1AS or IEEE 1588. Under such a standard, the time-synchronization system uses the best master clock algorithm (BMCA) to select a grand master clock (GMC), or a grandmaster, that is a device to be a clock source in the initial state.

The BMCA is an algorithm for a device to repeatedly compare priority information held by the device with priority information acquired from other devices to select a device with the highest priority among all the devices on the network as the grandmaster, or a master station. For example, as illustrated in FIG. 9, when the devices are powered on at the startup of the time-synchronization system, each device that performs the BMCA identifies the device as the master station. Each device then transmits an announcement being information including the priority information to the devices connected through the ports, and compares the priorities of the other devices acquired after receiving the announcements from the other devices with the priority of the device. Thus, the devices with clock IDs of 0×0003 and 0×0004 having the priorities of 3 and 4 that are greater than 1 and 2 each identify the device as a device station. The devices with clock IDs of 0×0001 and 0×0002 with the priorities that are yet to be compared transmit and receive the announcements again to and from each other to compare the priorities. The device with the clock ID of 0×0002 having the priority of 2that is greater than 1 then identifies the device as a slave. The device with the clock ID of 0×0001 having the priority of 1 is then selected as the grandmaster.

As an example of such a time-synchronization system, Patent Literature 1

describes a control system that includes switches and endpoints that are connected to a network and perform the BMCA to identify the grandmaster. In Patent Literature 1, the accuracy index of time synchronization is calculated for a timer selected as a candidate of the grandmaster based on the time accuracy of the timer and the path index of the controller including the timer. In Patent Literature 1, a timer with the highest accuracy index is then determined to be the grandmaster among multiple candidate timers, and priority setting information for setting the timer as the grandmaster is transmitted to the timer.

### CITATION LIST

### Patent Literature

Patent Literature 1: Unexamined Japanese Patent Application Publication No. 2021-051652

### SUMMARY OF INVENTION

### Technical Problem

The control system described in Patent Literature 1 repeatedly calculates and compares the accuracy indexes to determine the grandmaster and perform the BMCA, and may thus take a longer time before starting the time synchronization control.

Under such circumstances, an objective of the present disclosure is to shorten the time taken before starting the time synchronization control.

### Solution to Problem

To achieve the above objective, a time-synchronization system according to an aspect of the present disclosure includes a plurality of time-synchronization devices each to perform time synchronization as a master station or a device station connected to the master station to transmit and receive information to and from the master station. Each of the plurality of time-synchronization devices includes a master station determiner to determine whether the time-synchronization device including the master station determiner performs control as the master station based on a parameter predetermined by a user, and a time synchronizer to perform the time synchronization as the master station when the time-synchronization device including the master station determiner is determined to perform control as the master station, and perform the time synchronization as the device station when the time-synchronization device including the master station determiner is determined not to perform control as the master station.

### Advantageous Effects of Invention

Each time-synchronization device according to the above aspect of the present disclosure can determine whether the time-synchronization device performs control as the master station based on the parameter predetermined by the user. Thus, in the time-synchronization system according to the above aspect of present disclosure, the user can predetermine a time-synchronization device to be the master station when the time-synchronization device is pre-identified as most appropriate for the master station, without an algorithm for selecting the master station such as the BMCA being performed. Thus, the time-synchronization system according to the above aspect of the present disclosure can determine the time-synchronization device to be the master station more quickly than a time-synchronization system that performs an algorithm such as the BMCA to repeatedly compare information held by each time-synchronization device to determine a time-synchronization device most appropriate for the master station to be the master station, and can thus shorten the time taken before starting time synchronization control.

### BRIEF DESCRIPTION OF DRAWINGS

FIG. 1 is a schematic diagram of an entire time-synchronization system according to an embodiment;

FIG. 2 is a functional block diagram of the time-synchronization system;

FIG. 3 is a block diagram of a time-synchronization device, illustrating the hardware configuration;

FIG. 4A is a table illustrating an example display of parameter information;

FIG. 4B is a table illustrating an example display of connection information;

FIG. 4C is a table illustrating an example display of port information;

FIG. 5A is a diagram of an example of the time-synchronization system when powered on;

FIG. 5B is a timing chart of a port setting process;

FIG. 5C is a diagram of the example of the time-synchronization system after the port setting process;

FIG. 6 is a flowchart of a master station determination process;

FIG. 7 is a flowchart of a port information determination process;

FIG. 8 is a flowchart continuous from the flowchart in FIG. 7; and

FIG. 9 is a diagram describing a time-synchronization system performing the BMCA.

### DESCRIPTION OF EMBODIMENTS

A time-synchronization system, a time-synchronization device, a time-synchronization method, and a program according to one or more embodiments of the present disclosure are described in detail below with reference to the drawings. Like reference signs denote like or corresponding components in the drawings.

### Time-Synchronization System According to Embodiment

A time-synchronization system according to an embodiment of the present disclosure includes multiple time-synchronization devices on a network that each operate as a master station or a device station, and synchronizes time of the device station with time of the master station. In the time-synchronization system according to the present embodiment, the master station and the device station transmit and receive messages based on, for example, a standard such as Institute of Electrical and Electronics Engineers (IEEE) 802.1AS or IEEE 1588. The device station calculates a propagation delay time for the messages to and from the master station and corrects time to synchronize time between the master station and the device station. The time-synchronization system according to the present embodiment determines a grandmaster, or in other words, the master station, among the time-synchronization devices at a startup of the system, or more specifically, when the time-synchronization devices are powered on.

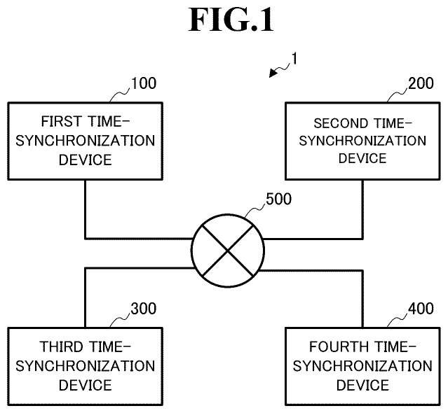

As illustrated in FIG. 1, a time-synchronization system 1 according to the present embodiment includes, as example time-synchronization devices, a first time-synchronization device 100, a second time-synchronization device 200, a third time-synchronization device 300, and a fourth time-synchronization device 400. The first time-synchronization device 100, the second time-synchronization device 200, the third time-synchronization device 300, and the fourth time-synchronization device 400 can transmit and receive information through a network 500.

### Time-Synchronization Device According to Embodiment

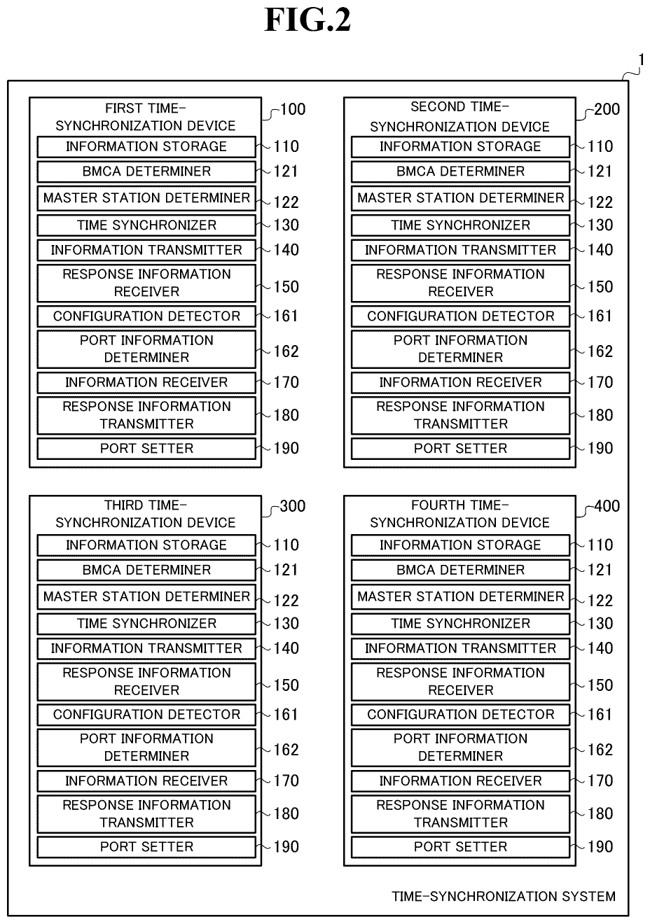

As illustrated in FIG. 2, the first time-synchronization device 100 includes an information storage 110 that stores information, a best master clock algorithm (BMCA) determiner 121 that determines whether the first time-synchronization device 100 performs the BMCA, a master station determiner 122 that determines whether first time-synchronization device 100 performs control as the master station, and a time synchronizer 130 that performs time synchronization as the master station or the device station. The first time-synchronization device 100 also includes an information transmitter 140 that transmits information to the device station when first time-synchronization device 100 is determined to perform control as the master station, and a response information receiver 150 that receives response information when first time-synchronization device 100 transmits information to the device station as the master station. The first time-synchronization device 100 also includes a configuration detector 161 that detects the configuration of connection with the device station as the master station, and a port information determiner 162 that determines port information about the device station as the master station. The first time-synchronization device 100 also includes an information receiver 170 that receives information from the master station when first time-synchronization device 100 is determined to perform control as the device station, a response information transmitter 180 that transmits the response information as the device station for the information transmitted from the master station, and a port setter 190 that sets ports.

Similarly to the first time-synchronization device 100, the second time-

synchronization device 200, the third time-synchronization device 300, and the fourth time-synchronization device 400 each include the information storage 110, the BMCA determiner 121, the master station determiner 122, and the time synchronizer 130. Similarly to the first time-synchronization device 100, the second time-synchronization device 200, the third time-synchronization device 300, and the fourth time-synchronization device 400 each include the information transmitter 140, the response information receiver 150, the configuration detector 161, the port information determiner 162, the information receiver 170, the response information transmitter 180, and the port setter 190 as well.

### Hardware Configuration of Time-Synchronization Device According to Embodiment

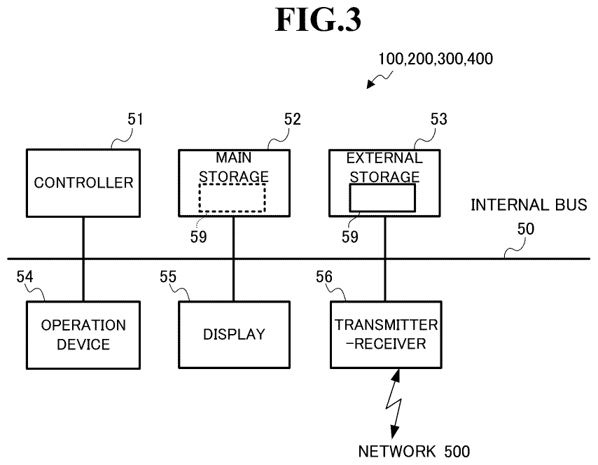

As illustrated in FIG. 3, the first time-synchronization device 100 includes, for example, a controller 51 that performs processes based on a control program 59. The controller 51 includes a central processing device (CPU). The controller 51 functions as, for example, the BMCA determiner 121, the master station determiner 122, the time synchronizer 130, the configuration detector 161, the port information determiner 162, and the port setter 190 illustrated in FIG. 2 based on the control program 59.

Referring back to FIG. 3, the first time-synchronization device 100 includes a main storage 52 in which the control program 59 is to be loaded. The main storage 52 is used as a work area for the controller 51. The main storage 52 includes a random-access memory (RAM).

The first time-synchronization device 100 includes an external storage 53 that prestores the control program 59. The external storage 53 provides information stored in the program to the controller 51 as instructed by the controller 51, and stores information provided from the controller 51. The external storage 53 includes a non-transitory recording medium such as a read-only memory (ROM), a flash memory, a hard disk drive (HDD), or a solid-state drive (SSD). The external storage 53 functions as, for example, the information storage 110 illustrated in FIG. 2.

Referring back to FIG. 3, the first time-synchronization device 100 includes an operation device 54 operable by a user. Input information is provided to the controller 51 through the operation device 54. The operation device 54 includes information input components such as a keyboard, a mouse, and a touchscreen.

The first time-synchronization device 100 also includes a display 55 that displays information input through the operation device 54 and information output from the controller 51. The display 55 includes a display device such as a liquid crystal display (LCD) or an organic light-emitting diode (OLED) display.

The first time-synchronization device 100 also includes a transmitter-receiver 56 that transmits and receives information. The transmitter-receiver 56 includes an information communication device such as a communication network termination device or a wireless communication device connected to a network. The transmitter-receiver 56 functions as, for example, the time synchronizer 130, the information transmitter 140, the response information receiver 150, the information receiver 170, and the response information transmitter 180 illustrated in FIG. 2.

Referring back to FIG. 3, in the first time-synchronization device 100, the main storage 52, the external storage 53, the operation device 54, the display 55, and the transmitter-receiver 56 are connected to the controller 51 with an internal bus 50.

The first time-synchronization device 100 implements the functions of the information storage 110, the BMCA determiner 121, the master station determiner 122, the time synchronizer 130, the information transmitter 140, the response information receiver 150, the configuration detector 161, the port information determiner 162, the information receiver 170, the response information transmitter 180, and the port setter 190 illustrated in FIG. 2, with the controller 51 using the main storage 52, the external storage 53, the operation device 54, the display 55, and the transmitter-receiver 56 as resources. For example, the first time-synchronization device 100 performs information storing with the information storage 110, BMCA determination with the BMCA determiner 121, and master station determination with the master station determiner 122. For example, the first time-synchronization device 100 performs time synchronization with the time synchronizer 130, information transmission with the information transmitter 140, response information reception with the response information receiver 150, configuration detection with the configuration detector 161, and port information determination with the port information determiner 162. For example, the first time-synchronization device 100 performs information reception with the information receiver 170, response information transmission with the response information transmitter 180, and the port setting with the port setter 190.

The second time-synchronization device 200, the third time-synchronization device 300, and the fourth time-synchronization device 400 each have the same hardware configuration as the first time-synchronization device 100. More specifically, the same hardware configuration as above applies to the second time-synchronization device 200 with the first time-synchronization device 100 replaced with the second time-synchronization device 200, to the third time-synchronization device 300 with the first time-synchronization device 100 replaced with the third time-synchronization device 300, and to the fourth time-synchronization device 400 with the first time-synchronization device 100 replaced with the fourth time-synchronization device 400. The hardware configurations of the second time-synchronization device 200, the third time-synchronization device 300, and the fourth time-synchronization device 400 are thus not described in detail to avoid redundancy.

### Details of Functional Configuration of Time-Synchronization Device According to Embodiment

Referring back to FIG. 2, the information storage 110 stores multiple types of information. The information storage 110 stores, for example, parameter information indicating parameters predetermined by the user, connection information about connection to other time-synchronization devices, priority information indicating the priority of the device including the information storage 110 in performing the BMCA, and clock ID information indicating a clock ID of the device including the information storage 110.

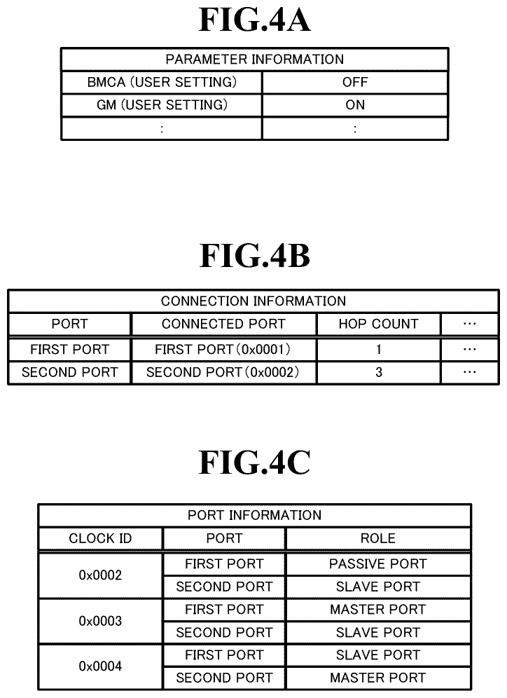

The parameter information is based on an input by the user using the operation device 54 and can be displayed in the form of a table illustrated in FIG. 4A. More specifically, the parameter information includes an item of BMCA (user setting) indicating whether to perform the BMCA, an item of GM (user setting) indicating whether to operate as the master station when not performing the BMCA, and values of the items. For example, the parameter information indicates the BMCA (user setting) being OFF and the GM (user setting) being ON. The value of the BMCA (user setting) in the parameter information is to be ON for all the time-synchronization devices or OFF for all the time-synchronization devices. The value of the GM (user setting) in the parameter information is to be ON for any one of the time-synchronization devices alone and OFF for all the remaining time-synchronization devices.

The connection information is set by each time-synchronization device and can be displayed in the form of a table illustrated in FIG. 4B. More specifically, the connection information includes information that can identify all the ports of each device station, information that can identify the port to which each port is connected, and information that can identify the hop count of each port from the master station. For example, the connection information indicates a first port connected to a first port 0×0001with the hop count of 1, and a second port connected to a second port 0×0002) with the hop count of 3. The priority information is set by each time-synchronization device to identify, for example, the priority of 3. The clock ID information is set by each time-synchronization device to identify, for example, the clock ID of 0×0003.

The BMCA determiner 121 refers to the parameter information stored in the information storage 110 after the device is powered on, and determines that the time-synchronization device performs the BMCA when the BMCA (user setting) is ON and determines that the time-synchronization device does not perform the BMCA when the BMCA (user setting) is OFF.

When the BMCA determiner 121 determines that the time-synchronization device including the BMCA determiner 121 performs the BMCA, the master station determiner 122 performs the BMCA to determine whether the time-synchronization device including the master station determiner 122 performs control as the master station. When the BMCA determiner 121 determines that the time-synchronization device including the BMCA determiner 121 does not perform BMCA, the master station determiner 122 refers to the parameter information stored in the information storage 110. The master station determiner 122 then determines that the time-synchronization device including the master station determiner 122 performs control as the master station when the GM (user setting) is ON, and determines that the time-synchronization device performs control as the device station when the GM (user setting) is OFF.

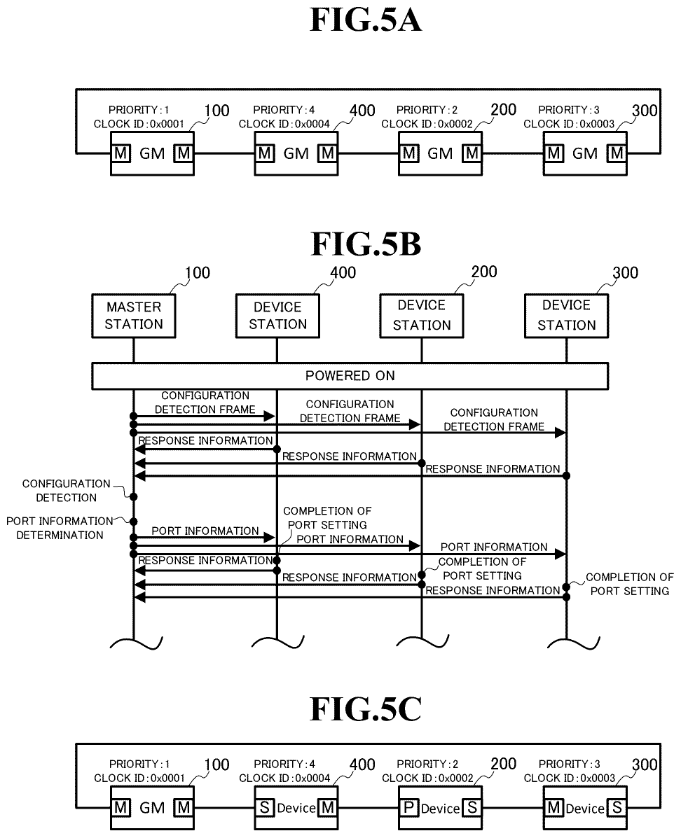

In an example, as illustrated in FIG. 5A, the time-synchronization system 1 includes the time-synchronization devices connected in a ring topology and has an initial setting to cause one of the time-synchronization devices to perform control as the master station when the time-synchronization devices are powered on. In this case, when the BMCA (user setting) is OFF and the GM (user setting) is ON in the parameter information in the first time-synchronization device 100, the first time-synchronization device 100 determines to perform control as the master station. In this case, the BMCA (user setting) and the GM (user setting) are OFF in the parameter information in the second time-synchronization device 200, the third time-synchronization device 300, and the fourth time-synchronization device 400. The second time-synchronization device 200, the third time-synchronization device 300, and the fourth time-synchronization device 400 thus determine to perform control as the device stations.

The time synchronizer 130 performs a time operation as the master station when the master station determiner 122 determines that the time-synchronization device including the master station determiner 122 performs control as the master station, and performs the time operation as the device station when the master station determiner 122 determines that the time-synchronization device including the master station determiner 122 performs control as the device station.

The configuration detector 161 detects the configuration of connection with the device stations when the master station determiner 122 determines that the time-synchronization device including the master station determiner 122 performs control as the master station. The configuration detector 161 first causes the information transmitter 140 to transmit, to all the devices stations, a configuration detection frame being an example of information that requests information used to detect the connection configuration. In the present embodiment, the information used to detect the configuration includes the connection information, the priority information, and the clock ID information. The configuration detector 161 then acquires the response information for the configuration detection frame received by the response information receiver 150 from each device station. The configuration detector 161 identifies, based on the acquired response information, the connection topology of the master station and the device stations, such as a bus, star, or ring topology, to detect the connection configuration.

Thus, in the example illustrated in FIG. 5A described above, the first time-synchronization device 100 being the master station transmits the configuration detection frame to the second time-synchronization device 200, the third time-synchronization device 300, and the fourth time-synchronization device 400 being the device stations, and receives, as the response information, the connection information, the priority information, and the clock ID information about each device station as illustrated in FIG. 5B. The first time-synchronization device 100 then detects the connection configuration based on the connection information. More specifically, the first time-synchronization device 100 identifies the first port of the first time-synchronization device 100 and the second port of the third time-synchronization device 300 as being connected to each other, and the second port of the first time-synchronization device 100 and the first port of the fourth time-synchronization device 400 as being connected to each other. The first time-synchronization device 100 also identifies the first port of the second time-synchronization device 200 and the second port of the fourth time-synchronization device 400 as being connected to each other, and the second port of the second time-synchronization device 200 and the first port of the third time-synchronization device 300 as being connected to each other. The first time-synchronization device 100 can thus identify the time-synchronization devices as being connected in a ring topology.

The port information determiner 162 determines the port information about the device stations based on the response information acquired by the configuration detector 161. The port information determiner 162 first determines whether the master station and the device stations are connected in a ring topology based on the detection results from the configuration detector 161. When the devices are not connected in a ring topology and connected in, for example, a bus or star topology, the port information determiner 162 determines the ports that receive information from the master station to be slave ports, and the remaining ports that do not receive information from the master station to be master ports.

When the devices are connected in a ring topology, the port information determiner 162 identifies, for each device, the hop count of each port from the master station based on the connection information. The port information determiner 162 also determines, for each device station having ports with different hop counts, the port with a smaller hop count to be the slave port and the port with a greater hop count to be the master port. The port information determiner 162 also compares, for each device station having ports with the same hop count, clock ID values of the device stations connected to the respective ports identified from the clock ID information, and determines the port connected to the device station with a smaller clock ID value to be the slave port and the port connected to the device station with a greater clock ID value to be a passive port.

The port information determiner 162 then generates the port information indicating the roles of the identified ports of each slave to determine the port information. The port information is set by the master station and can be displayed in the form of a table illustrated in FIG. 4C. More specifically, the port information includes information that can identify all the ports and the roles of the ports for each device station. The port information indicates, for example, that the first port of the device station with the clock ID of 0×0002 is the passive port and the second port is the slave port.

When the master station determiner 122 determines that the time-synchronization device including the master station determiner 122 performs control as the master station, the port setter 190 sets all the ports of the time-synchronization device as the master ports. When the master station determiner 122 determines that the time-synchronization device including the master station determiner 122 performs control as the device station, the port setter 190 sets each port of the time-synchronization device to one of the master port, the slave port, or the passive port based on the port information received by the information receiver 170.

As illustrated in FIG. 5B, when the master station determiner 122 determines that the time-synchronization device including the master station determiner 122 performs control as the master station, the information transmitter 140 transmits the configuration detection frame to all the device stations, and the response information receiver 150 receives, as the response information, the information used to detect the configuration held by each device station. When the port information determiner 162 determines the port information, the information transmitter 140 as an example of a port information transmitter transmits the port information to all the device stations, and the response information receiver 150 receives, as the response information, information indicating completion of port setting by each device station.

When the master station determiner 122 determines that the time-synchronization device including the master station determiner 122 performs control as the device station, the information receiver 170 receives the configuration detection frame from the master station, and the response information transmitter 180 transmits the information used to detect the configuration as the response information. The information receiver 170 as an example of a port information receiver receives the port information from the master station, and when the port setter 190 sets each port, the response information transmitter 180 transmits the information indicating the completion of the port setting as the response information.

Thus, in the example illustrated in FIG. 5A described above, the first time-synchronization device 100 being the master station identifies the time-synchronization devices as being connected in a ring topology based on the detection results described above, and identifies the hop counts of the ports of the second time-synchronization device 200, the third time-synchronization device 300, and the fourth time-synchronization device 400 being the device stations based on the connection information. More specifically, the first time-synchronization device 100 identifies the second time-synchronization device 200 as having the first port and the second port each with the hop count of 2, the third time-synchronization device 300 as having the first port with the hop count of 2 and the second port with the hop count of 1, and the fourth time-synchronization device 400 as having the first port with the hop count of 1 and the second port with the hop count of 3.

The first time-synchronization device 100 also determines the roles of the ports of the third time-synchronization device 300 and the fourth time-synchronization device 400 each having the ports with different hop counts. More specifically, the first time-synchronization device 100 determines that the first port of the third time-synchronization device 300 is the master port and the second port is the slave port, and the first port of the fourth time-synchronization device 400 is the slave port and the second port is the master port. The first time-synchronization device 100 also determines the roles of the ports of the second time-synchronization device 200 having the ports with the same hop count. More specifically, the first time-synchronization device 100 determines that the first port of the second time-synchronization device 200 connected to the fourth time-synchronization device 400 with a greater clock ID value of 0×0004 is the passive port, and the second port of the second time-synchronization device 200 connected to the third time-synchronization device 300 with a smaller clock ID value of 0×0003 is the slave port. The first time-synchronization device 100 can thus generate the port information indicating the determined roles of the ports of the device stations.

As illustrated in FIG. 5B, the first time-synchronization device 100 then transmits the generated port information to the second time-synchronization device 200, the third time-synchronization device 300, and the fourth time-synchronization device 400, and receives, as the response information, the information indicating the completion of the port setting from each device station. As illustrated in FIG. 5C, the first time-synchronization device 100, the second time-synchronization device 200, the third time-synchronization device 300, and the fourth time-synchronization device 400 can thus set the roles of the ports.

### Flowchart of Master Station Determination Process in Present Embodiment

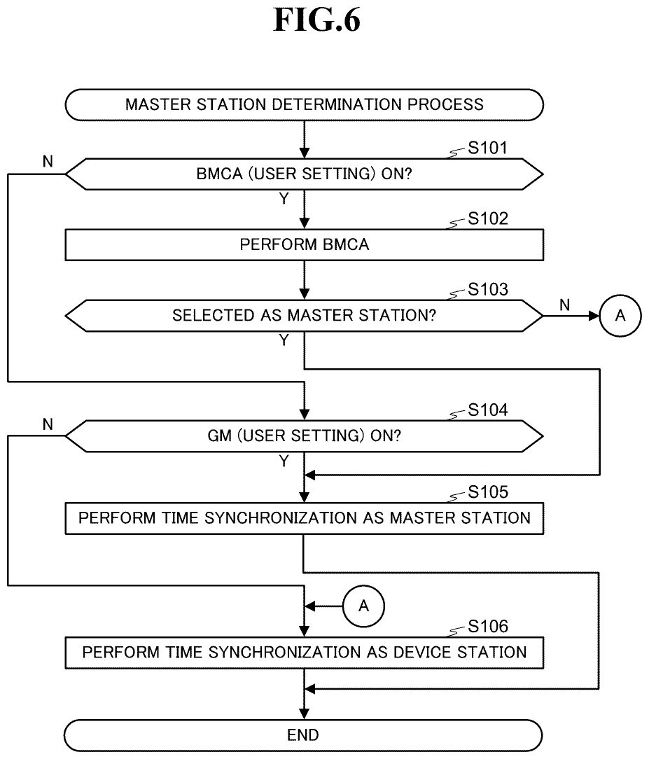

The operation of each time-synchronization device to determine whether to perform control as the master station is now described with reference to the flowchart illustrated in FIG. 6. When powered on, each time-synchronization device starts performing a master station determination process illustrated in FIG. 6. As illustrated in FIG. 6, the BMCA determiner 121 first refers to the parameter information stored in the information storage 110 after the time-synchronization device including the BMCA determiner 121 is powered on, and determines whether the BMCA (user setting) is ON (step S101). When the BMCA (user setting) is ON (Yes in step S101), the BMCA determiner 121 determines that the time-synchronization device including the BMCA determiner 121 performs the BMCA. The master station determiner 122 performs the BMCA (step S102) and determines whether the time-synchronization device including the master station determiner 122 is selected as the master station (step S103).

When the BMCA (user setting) is OFF (No in step S101), the BMCA determiner 121 determines that the time-synchronization device including the BMCA determiner 121 does not perform the BMCA. The master station determiner 122 refers to the parameter information stored in the information storage 110 and determines whether the GM (user setting) is ON (step S104). When the time-synchronization device including the master station determiner 122 is selected as the master station (Yes in step S103) or when the GM (user setting) is ON (Yes in step S104), the master station determiner 122 determines that the time-synchronization device including the master station determiner 122 performs control as the master station. The time synchronizer 130 performs the time operation as the master station (step S105) and ends the process. When the time-synchronization device is not selected as the master station (No in step S103) or when the GM (user setting) is OFF (No in step S104), the master station determiner 122 determines that the time-synchronization device performs control as the device station. The time synchronizer 130 performs the time operation as the device station (step S106) and ends the process.

### Flowchart of Port Information Determination Process in Present Embodiment

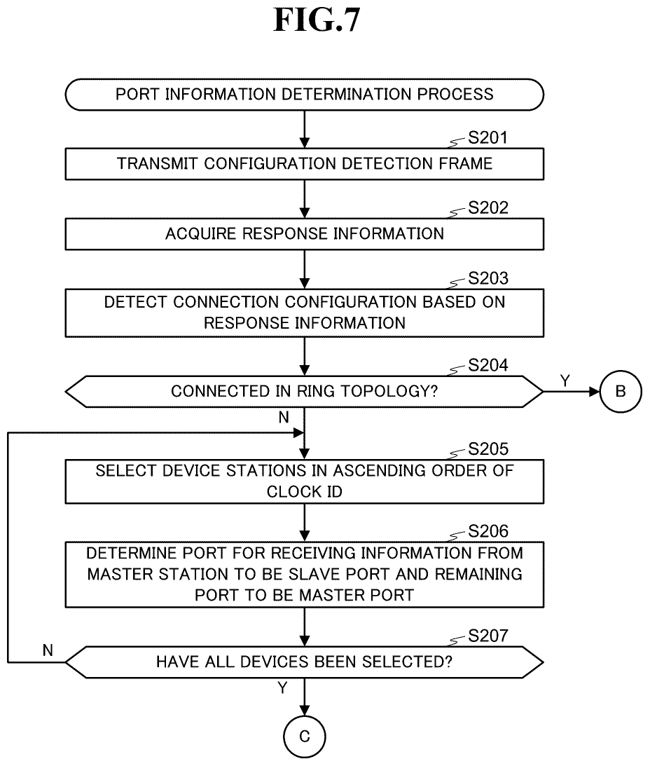

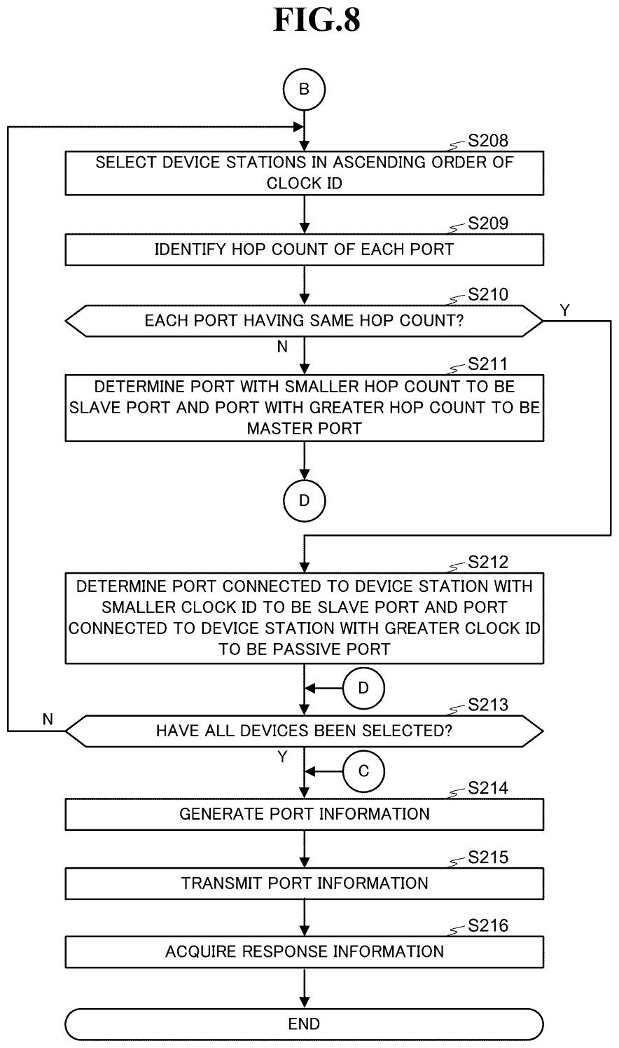

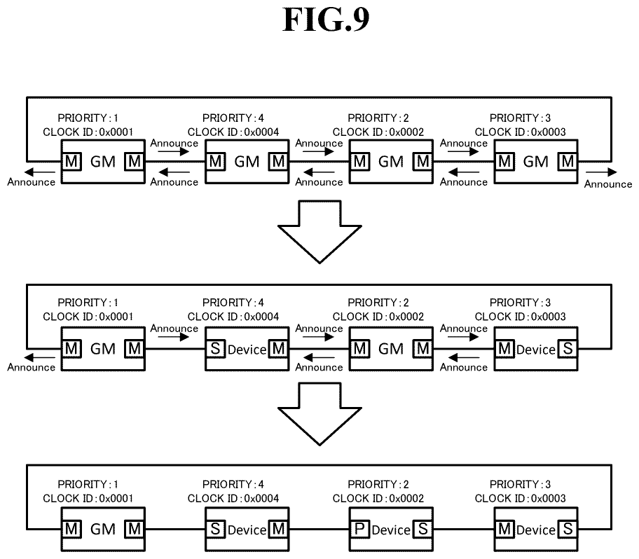

The operation of the master station to determine the port information about the device stations is now be described with reference to the flowcharts illustrated in FIGS. 7 and 8. When the master station determiner 122 determines that the time-synchronization device including the master station determiner 122 performs control as the master station, the time-synchronization devices each start a port information determination process illustrated in FIGS. 7 and 8. As illustrated in FIG. 7, the configuration detector 161 first causes the information transmitter 140 to transmit the configuration detection frame to all the device stations (step S201), and the response information receiver 150 acquires the response information received from each device station (step S202). The configuration detector 161 detects the connection configuration based on the response information (step S203).

The port information determiner 162 then determines whether the master station and the device stations are connected in a ring topology based on the detection results from the configuration detector 161 (step S204). When the devices are not connected in a ring topology (No in step S204), the port information determiner 162 selects the device stations in ascending order of the clock ID value based on the clock ID information (step S205). The port information determiner 162 then determines, for each selected device station, the port that receives information from the master station to be the slave port and the remaining port that does not receive information from the master station to be the master port (step S206). The port information determiner 162 then determines whether all the device stations have been selected (step S207). When not all the device stations have been selected (No in step S207), the port information determiner 162 returns to step S205 and repeats the processing in steps S205 and S206 until all the device stations are selected.

When the devices are connected in a ring topology (Yes in step S204), the port information determiner 162 selects the device stations in ascending order of the clock ID value as illustrated in FIG. 8 (step S208). The port information determiner 162 then identifies, for each selected device, the hop count of each port based on the connection information (step S209) and determines whether the hop counts of the ports are the same (step S210). When the hop counts vary (No in step S210), the port information determiner 162 determines, for the selected device station, the port with a smaller hop count to be the slave port and the port with a greater hop count to be the master port (step S211). When the hop counts are the same (Yes in step S210), the port information determiner 162 compares the clock ID values of the device stations adjacent to the respective ports identified based on the clock ID information, and determines the port connected to the device station with a smaller ID value to be the slave port and the port connected to the device station with a greater ID value to be the passive port (step S212).

After determining the roles of the ports of the selected device station in steps S211 and S212, the port information determiner 162 determines whether all the device stations have been selected (step S213). When not all the device stations have been selected (No in step S213), the port information determiner 162 returns to step S208 and repeats the processing in steps S208 to S212 until all the device stations are selected. After determining the roles of the ports of the selected device stations in step S207 or S213, the port information determiner 162 generates the port information (step S214), and causes the information transmitter 140 to transmit the port information to all the device stations (step S215). The response information receiver 150 acquires the response information received from each device station (step S216) and ends the process.

As described above, in the time-synchronization system 1 according to the present embodiment, the first time-synchronization device 100, the second time-synchronization device 200, the third time-synchronization device 300, and the fourth time-synchronization device 400 each include the master station determiner 122 that can determine whether the time-synchronization device including the master station determiner 122 performs control as the master station based on the parameter predetermined by the user. When the master station determiner 122 determines that the time-synchronization device performs control as the master station, the time synchronizer 130 performs the time synchronization as the master station. When the master station determiner 122 determines that the time-synchronization device does not perform control as the master station, the time synchronizer 130 performs the time synchronization as the device station.

Thus, in the time-synchronization system 1 according to the present embodiment, the user can predetermine a time-synchronization device to be the master station when, for example, a time-synchronization device as a server that functions as a management station is pre-identified and the user intends the pre-identified time-synchronization device to perform the time synchronization as the master station. In other words, in the time-synchronization system 1 according to the present embodiment, the user can predetermine a time-synchronization device to be the master station when the time-synchronization device is pre-identified as most appropriate for the master station, without an algorithm for selecting the master station such as the BMCA being performed. Thus, the time-synchronization system 1 according to the present embodiment can determine the time-synchronization device to be the master station more quickly than a time-synchronization system that performs an algorithm such as the BMCA to repeatedly compare information held by each time-synchronization device to determine a time-synchronization device most appropriate for the master station to be the master station, and can thus shorten the time taken before starting the time synchronization control.

In the time-synchronization system 1 according to the present embodiment, when the first time-synchronization device 100, the second time-synchronization device 200, the third time-synchronization device 300, or the fourth time-synchronization device 400 performs the time synchronization as the master station, the configuration detector 161 detects the configuration of connection with the device stations. In this case, the port information determiner 162 determines the port information about the device stations based on the detected configuration, and the information transmitter 140 as an example of the port information transmitter transmits the determined port information to the device stations. When the first time-synchronization device 100, the second time-synchronization device 200, the third time-synchronization device 300, or the fourth time-synchronization device 400 performs the time synchronization as the device station, the information receiver 170 as an example of the port information receiver receives the port information, and the port setter 190 sets the port based on the port information.

Thus, in the time-synchronization system 1 according to the present embodiment, the master station can determine the port information about the device stations and cause the device stations to set the ports. The time-synchronization system 1 according to the present embodiment can thus set the ports of each device station more quickly than a time-synchronization system in which each device station determines the port information and sets the ports of the device station, and can thus shorten the time taken before starting the time synchronization control.

In the time-synchronization system 1 according to the present embodiment, the first time-synchronization device 100, the second time-synchronization device 200, the third time-synchronization device 300, and the fourth time-synchronization device 400 each include the BMCA determiner 121 that determines whether the time-synchronization device performs the BMCA based on the parameter predetermined by the user. When the time-synchronization device is determined to perform the BMCA, the master station determiner 122 performs the BMCA to determine whether the time-synchronization device performs control as the master station. When the time-synchronization device is determined not to perform the BMCA, the master station determiner 122 determines whether the time-synchronization device performs control as the master station based on the parameter.

Thus, in the time-synchronization system 1 according to the present embodiment, the user can predetermine whether to perform the BMCA. In the time-synchronization system 1 according to the present embodiment, for example, the BMCA can be performed to determine the master station when a time-synchronization device to function as the management station is not pre-identified and a time-synchronization device most appropriate for the master station among all the time-synchronization devices is to be determined using the time before the start of the time synchronization control. In other words, in the synchronization system 1 according to the present embodiment, the user can perform the BMCA to select the master station when a time-synchronization device most appropriate for the master station is not pre-identified.

### Modifications

In the present embodiment, the parameters predetermined by the user are stored in the information storage 110 in each time-synchronization device as the parameter information, and the time-synchronization device refers to the stored parameter information. However, the parameter information may be stored differently. For example, the parameter information may be stored in a database server different from the time-synchronization device, and the time-synchronization device may acquire the parameter information stored in the database server. In this case, the database server may be a server in the time-synchronization system 1, or may be an external device on the network.

In the present embodiment, the master station transmits the configuration detection frame to all the device stations and receives, as the response information from each device station, the information used to detect the connection configuration. However, the information may be received differently. For example, the device station may transmit the information used to detect the connection configuration to the master station when determining to perform the time synchronization as the device station. This allows the master station to acquire the information used to detect the connection configuration without transmitting the configuration detection frame.

As in the present embodiment, each time-synchronization device may determine whether to perform the BMCA based on the parameter predetermined by the user. However, the time-synchronization device may perform the determination differently. For example, the BMCA (user setting) in the parameter information may be eliminated, and each time-synchronization device may always determine whether to perform control as the master station based on a parameter predetermined by the user without performing the BMCA.

The main operating portions of the first time-synchronization device 100,

the second time-synchronization device 200, the third time-synchronization device 300, and the fourth time-synchronization device 400 each including the controller 51, the main storage 52, the external storage 53, the operation device 54, the display 55, and the transmitter-receiver 56 connected to one another with the internal bus 50 can be implemented by a common computer system instead of a dedicated system. For example, a computer program for performing the above operation may be stored in a non-transitory computer-readable recording medium, such as a flash memory or a digital versatile disc read-only memory (DVD-ROM), distributed, and installed in a computer to implement the first time-synchronization device 100, the second time-synchronization device 200, the third time-synchronization device 300, and the fourth time-synchronization device 400 that perform the above processes. The computer program may be stored in a storage device in a server on a communication network such as the Internet, and downloaded to a common computer system to implement the first time-synchronization device 100, the second time-synchronization device 200, the third time-synchronization device 300, and the fourth time-synchronization device 400.

When the functions of the first time-synchronization device 100, the second time-synchronization device 200, the third time-synchronization device 300, and the fourth time-synchronization device 400 are implemented partially by an operating system (OS) and partially by an application program, or through cooperation between the OS and the application program, portions of the application program alone may be stored in a non-transitory recording medium or a storage device.

The computer program may be superimposed on a carrier wave to be provided through a communication network. For example, the computer program may be posted on a bulletin board system (BBS) on a communication network to be provided through the network. The above process may be performed by activating the computer program and performing the program in the same manner as in the other application programs under the control of the OS.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Time-synchronization system
50 Internal bus
51 Controller
52 Main storage
53 External storage
54 Operation device
55 Display
56 Transmitter-receiver
59 Control program
100 First time-synchronization device
110 Information storage
121 BMCA determiner
122 Master station determiner
130 Time synchronizer
140 Information transmitter
150 Response information receiver
161 Configuration detector
162 Port information determiner
170 Information receiver
180 Response information transmitter
190 Port setter
200 Second time-synchronization device
300 Third time-synchronization device
400 Fourth time-synchronization device
500 Network

1. A time-synchronization system, comprising:
a plurality of time-synchronization devices each to perform time synchronization as a master station that is a grandmaster or a device station connected to the master station to transmit and receive information to and from the master station,
wherein each of the plurality of time-synchronization devices includes processing circuitry, a storage, and a transmitter-receiver,
the storage holds, as a parameter of the time-synchronization device predetermined by a user, information indicating that the time-synchronization device holding the parameter performs control as the master station or information indicating that the time-synchronization device holding the parameter does not perform control as the master station,
the processing circuitry
determines that the time-synchronization device holding the parameter performs control as the master station when the held parameter is the information indicating that the time-synchronization device holding the parameter performs control as the master station and determines that the time-synchronization device holding the parameter does not perform control as the master station when the held parameter is the information indicating that the time-synchronization device holding the parameter does not perform control as the master station, and
performs the time synchronization as the master station when the time-synchronization device holding the parameter including the master is determined to perform control as the master station, and performs the time synchronization as the device station when the time-synchronization device holding the parameter is determined not to perform control as the master station.

2. The time-synchronization system according to claim 1, wherein
the processing circuit
detects a configuration of connection with the device station when the time-synchronization device holding the parameter perform the time synchronization as the master station, and
determines port information about the device station based on the detected configuration when the time-synchronization device holding the parameter perform the time synchronization as the master station,
the transmitter-receiver
transmits the determined port information to the device station when the time-synchronization device holding the parameter perform the time synchronization as the master station, and
receives the port information when the time-synchronization device holding the parameter perform the time synchronization as the device station, and
the processing circuitry
sets a port based on the port information when the time-synchronization device holding the parameter perform the time synchronization as the device station,
identifies a connection topology of the master station and the device station based on connection information including information with which all ports of the device station are identifiable, information with which a port to which each port of the device station is connected is identifiable, and information with which a hop count of each port of the device station from the master station is identifiable, and
determines a role of each port of the device station based on the connection topology of the master station and the device station, the hop count of each port of the device station identified from the connection information, a clock identification (ID) information that is information indicating a clock ID of the device station.

3. The time-synchronization system according to claim 1, wherein
the processing circuitry
determines whether the time-synchronization device holding the parameter performs a BMCA based on the parameter, and the BMCA is a best master clock algorithm, and
performs the BMCA to determine whether the time-synchronization device holding the parameter performs control as the master station when the BMCA is determined to be performed, and determine whether the time-synchronization device holding the parameter performs control as the master station based on the parameter when the BMCA is determined not to be performed.

4. A time-synchronization device for performing time synchronization as a master station that is a grandmaster or a device station connected to the master station to transmit and receive information to and from the master station, the time-synchronization device comprising processing circuitry, a storage, and a transmitter-receiver:
the storage holds, as a parameter of the time-synchronization device predetermined by a user, information indicating that the time-synchronization device performs control as the master station or information indicating that the time-synchronization device does not perform control as the master station,
the processing circuitry
determines that the time-synchronization device performs control as the master station when the held parameter is the information indicating that the time-synchronization device performs control as the master station and determines that the time-synchronization device does not perform control as the master station when the held parameter is the information indicating that the time-synchronization device does not perform control as the master station; and
performs the time synchronization as the master station when the time-synchronization device is determined to perform control as the master station, and performs the time synchronization as the device station when the time-synchronization device is determined not to perform control as the master station.

5. (canceled)

6. A non-transitory computer-readable recording medium storing a program, the program causing a computer to execute processing comprising:
holding, as a parameter of the computer predetermined by a user, information indicating that the computer performs control as the master station that is a grandmaster of a time-synchronization system or information indicating that the computer does not perform control as the master station,
determining that the computer performs control as the master station when the held parameter is the information indicating that the computer performs control as the master station and determining that the computer does not perform control as the master station when the held parameter is the information indicating that the computer does not perform control as the master station; and
performing time synchronization as the master station when the computer is determined to perform control as the master station, and performing the time synchronization as a device station in the time-synchronization system when the computer is determined not to perform control as the master station.
